(19) United States
(12) Patent Application Publication
(10) Pub. No.: US 2016/0248972 A1
(43) Pub. Date: Aug. 25, 2016

(54) Panoramic Game Camera

(71) Applicants: Jeff Garrison, Decatur, AL (US); Bart Stephens, Birmingham, AL (US); Alex Ng, Hong Kong (HK); Patrick Cheung, Hong Kong (HK)

(72) Inventors: Jeff Garrison, Decatur, AL (US); Bart Stephens, Birmingham, AL (US); Alex Ng, Hong Kong (HK); Patrick Cheung, Hong Kong (HK)

(73) Assignee: EBSCO INDUSTRIES, INC, Birmingham, AL (US)

(21) Appl. No.: 14/628,566

(22) Filed: Feb. 23, 2015

(51) Int. Cl. H04N 5/232; H04N 5/247; H04N 7/18; H04N 5/225

(52) U.S. Cl. CPC H04N 5/23238; H04N 5/2256; H04N 5/247; H04N 7/188; H04N 7/181

(57) ABSTRACT

A surveillance camera, useful for capturing the movement of an animate object across a wide field of view, includes three separate lens apertures having fixed and adjacent fields of view. Each lens aperture has an associated image sensor that captures the field of view for combination by a microprocessor unit to yield a panoramic image.

FIELD OF INVENTION

The present invention relates generally to the field of hunting and more specifically to game cameras used by hunters to monitor the presence and activity of game animals in the wild. In even greater particularity, the present invention relates to a game camera for capturing images or video of game animals in the wild wherein the camera is activated by movement of the animal within a panoramic view of the camera, or triggered at a specific time, or may include a time lapse or delay. In still further particularity, the present invention is related to a game camera in which multiple lenses are directed to contiguous portions of a panoramic view and images are captured through each lens when the camera system is actuated by the movement of an animal within the panoramic view.

### BACKGROUND

Game cameras, also referred to as motion detector cameras, trail cameras, or surveillance cameras, are widely used by hunters to monitor areas of interest such as near feeders or food plots or known game trails to determine what animals are visiting these areas. Such cameras have become increasingly sophisticated, yet the hunter is constantly wondering what might have been just outside the field of view of the camera when an image was captured. Accordingly attempts have been made to expand the field of view of the camera. Some of these attempts have included multiple lenses and multiple motion detectors.

Others have included a single camera lens that moves about a vertical axis to take pictures over a wide panoramic arc. Some cameras even purport to provide 360 degree images. The known cameras have not proven satisfactory due to a variety of reasons including the movement of the single camera to take images across the viewing area, and the complexity of matching images from three lenses.

### SUMMARY OF THE INVENTION

A general object of the invention is to allow the user to monitor activity during times when he is not present on site. This monitoring is achieved by utilizing a game or trail camera in an area such that when a certain time has elapsed or a subject moves within the detection area of the camera, it will capture a still image or photo of the subject for later review.

A more specific object of the invention is to allow the end user to monitor a larger area in a manner that not only allows for a larger area of detection and image capture, but also by responding more accurately as to where the original movement is detected.

Yet another object of the invention is to reduce or eliminate moving parts that may wear out over time in a wide angle camera system.

Still another object of the invention is to provide for silent operation to avoid spooking game animals.

A further object of the invention is a confirmed field of view achieved by consistent positioning of each sensor and consistent alignment of individual images resulting in a final panoramic image with no unintended overlap or gap between sections.

Another object of the invention is to obtain more rapid sequencing and capture of images.

An advantage over certain prior art devices is increased battery life due to not needing to drive and control a motor to move an image sensor to the desired position.

Still another advantage over prior Moultrie devices is a lack of moving parts to interfere with audio recording, thus, the device can accommodate a microphone and audio capture component when capturing video.

### BRIEF DESCRIPTION OF THE DRAWINGS

Referring to the drawings which are appended hereto and which form a portion of this disclosure, it may be seen that:

FIG. 1 is diagrammatic view of the field of view of the instant camera;

FIG. 2 is a block diagram of the major active components;

FIG. 3 is a front elevation view of the camera housing showing the camera apertures and PIR detectors;

FIG. 4 is a side elevation view of the camera housing;

FIG. 5 is a bottom view of the camera housing;

FIGS. 6a to 6c are depictions of the scene within the field of view each of the camera apertures when in a single view mode;

FIGS. 7a to 7c are depictions of the scene within the field of view each of the camera apertures when in a panoramic view mode; and,

FIG. 8 is a depiction of the combined panoramic image stored by the camera unit.

FIG. 9 is a flow chart of the color correction methodology of various embodiments.

### DETAILED DESCRIPTION

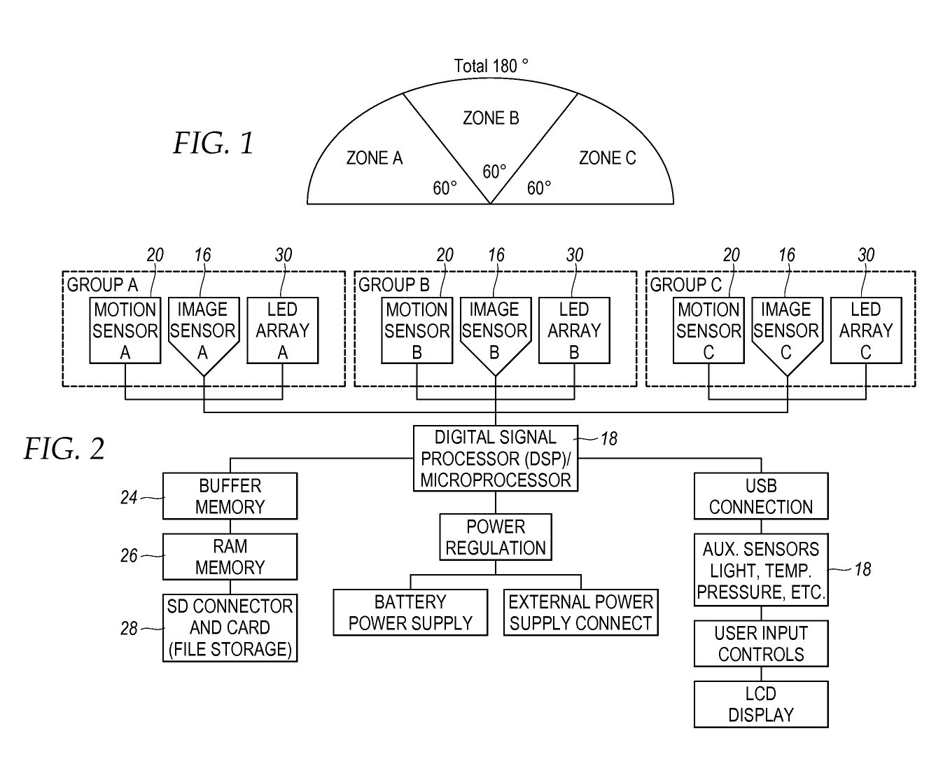

Referring to FIG. 1, it may be seen that the present camera system is intended to capture a combined image that covers a wide or “panoramic” field of view. Within the panoramic field of view are three zones such that the camera operates as a single camera with a 180° or greater detection zone and field of view by capturing separate images sequentially in each zone and combining them through image post-processing. The term images as used herein should be construed to include the capture of video imagery.

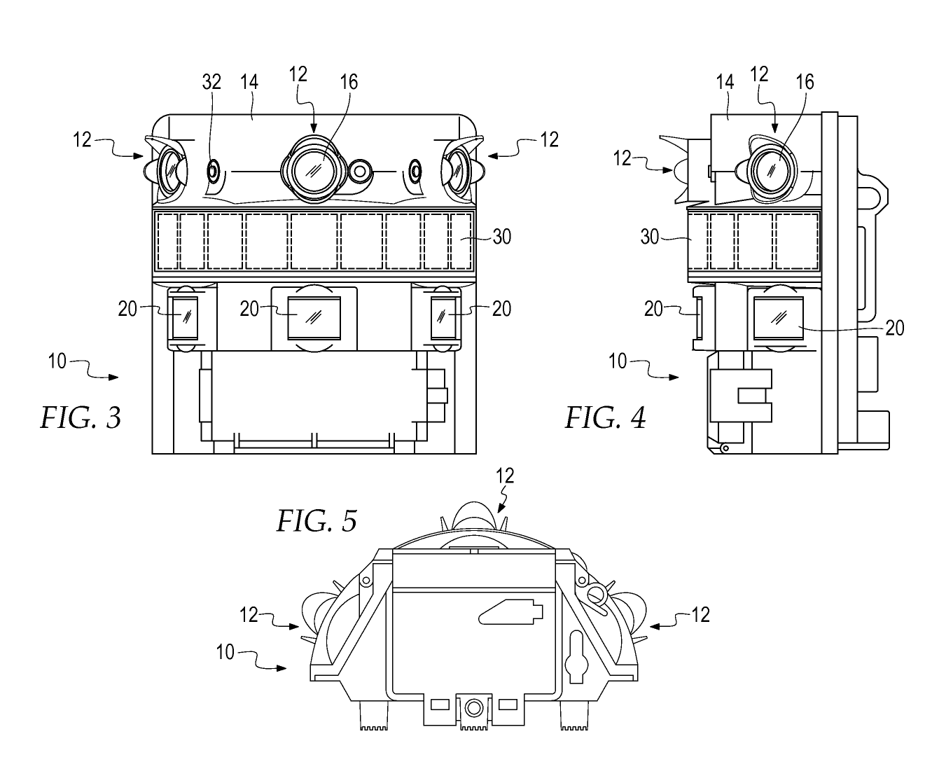

Referring to FIGS. 3 to 5, in one embodiment the camera unit 10 utilizes three camera apertures 12 facing radially outward from a housing 14. The housing 14 fixes the camera apertures 12 in place with the apertures 12 located about a common center and on a common plane. As illustrated in FIG. 1, each of the apertures 12 has a field of view of from 40 to 75 degrees and preferably about 60 degrees with the field of view of each of the plurality of camera apertures 12 bounded by the field of view of each adjacent aperture 12. The housing 14 maintains each aperture cooperatively positioned relative to an associated image capture sensor 16 mounted therein such that the field of view of the associated aperture 12 is focused on the image capture sensor 16 by appropriate lenses. Each image capture sensor 16 is coupled to a microprocessor unit 18 receiving electronic image input from each of the associated image capture sensors 16. The microprocessor unit 18 is programmed to selectively combine each electronic image input to yield a panoramic image spanning the combined field of view of all of the plurality of apertures 12. In one embodiment the unit uses a plurality of motion detector sensors 20, each motion detector sensor 20 associated with one of the plurality of camera apertures 12 and having a field of view coextensive with its associated camera aperture 12. Each of the motion detector sensors 20 is operatively connected to the microprocessor unit 18 to provide an input thereto indicative of a moving body in a field of view coextensive with an associated one of said plurality of camera apertures 12. Microprocessor unit 18 is programmed to activate at least the image capture sensor 16 having the moving body within its focused field of view when the microprocessor unit 18 receives the input from the motion detector sensor 20. An electronic memory 22, which may include a buffer memory 24, ram memory 26 and removable storage 28 such as an SD card, is connected to the microprocessor unit 18 for storing data including said electronic image input and said panoramic image.

Also as seen in FIGS. 2 to 5, the unit includes an LED array 30 comprised of a plurality of LED emitters positioned to illuminate the field of view associated with the camera apertures. The microprocessor unit 18 is programed to selectively activate a plurality of LEDs in the LED array 30 which are positioned to illuminate the field of view of a camera aperture 12 in which a moving body has been detected by one of the plurality of motion detector sensor 20s. Of course, if the images are captured during daylight hours the LED array 30 may not be necessary, therefore a light sensor 32 for detecting the ambient light and in communication the microprocessor unit 18 such that the microprocessor unit 18 selectively activates the LED array 30 when said detected ambient light is below a predetermined threshold.

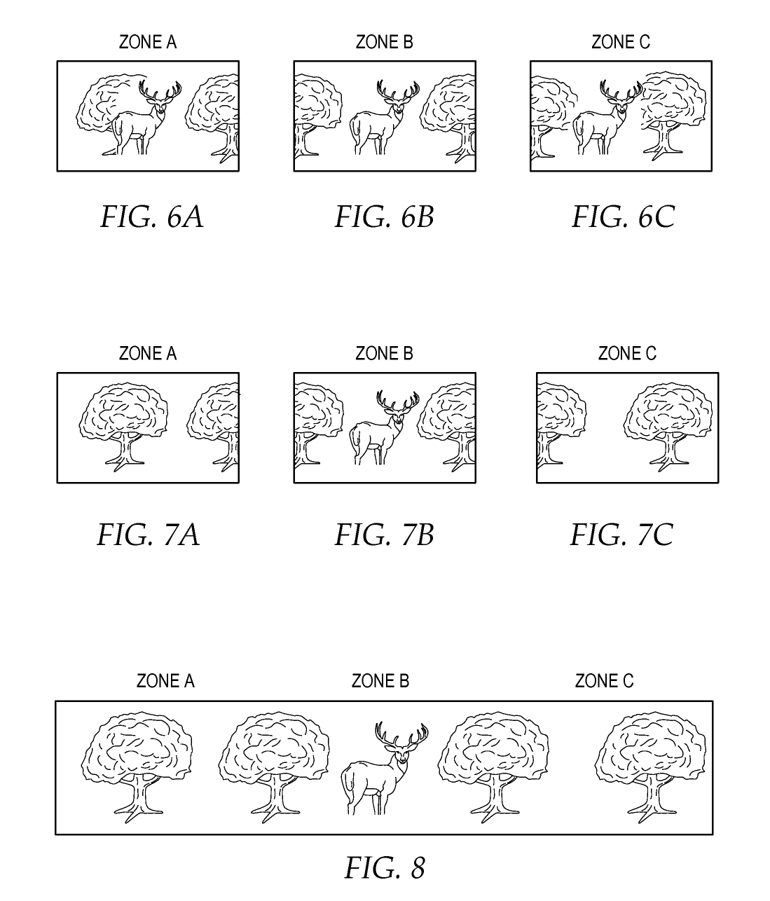

For SINGLE MODE capture, the camera unit 10 operates similar to three independent cameras within a single housing 14, detecting and capturing still photos or videos within the zone respective to where the motion is detected and utilizing that zone's individual image sensor 16 and LED array 30 (when required) to create a single 40° to 70° horizontal field of view image. Differing from similar products, such as Moultrie's current Panoramic 150 camera, this requires no movement within the device to get the image sensor 16 and LED array 30 into the position required to capture the image in the zone wherein the movement was detected, resulting in completely silent operation and more rapid capture, as well as consistent positioning and alignment and longer lifespan due to lack of moving parts which may wear out. Examples of the output of the device in this mode would be single still images or videos capturing game in each independent zone as illustrated in FIGS. 6a, 6b and 6c.

For PANORAMIC MODE capture, the camera operates as a single camera with a 180° detection zone and field of view by capturing separate images sequentially in each zone and combining them through image post-processing. Such image processing can be accomplished with varying degrees of complexity. In one embodiment, a direct combination of the images in each field of view is accomplished such that the image from zone A is place adjacent the image from zone B and the image from zone B is placed against the image of zone c to create a new panoramic output image with resolution equal to 1 times the height of each image zone and 3 times the width of each image zone. In this embodiment the edge alignment of the adjacent zones is disregarded. In a second embodiment the alignment of each edge of the adjacent zones undergoes pattern alignment such that microprocessor unit 18 will review edges of each adjacent zone image A & B and B & C, and extract similar edge pattern via review of RGB values and light patterns. The microprocessor unit will then align patterns with minimal overlap (1-2 pixel columns) to correct for any manufacturing tolerance in image sensor 16 plane elevations. In the third embodiment microprocessor unit 18 will apply distortion compensation to zones A and C to optically align their content with that of zone B and then apply the second apply distortion compensation to zones A and C to optically align their content with that of zone B and then apply pattern alignment for final combination into the panoramic image stored by the memory.

Examples of the output of the device in this mode would be a single still image capturing game in an initial starting zone and additional captures of the remaining two zones as illustrated in FIGS. 7a, 7b, and 2c. These images are then combined into a single image as illustrated in FIG. 8.

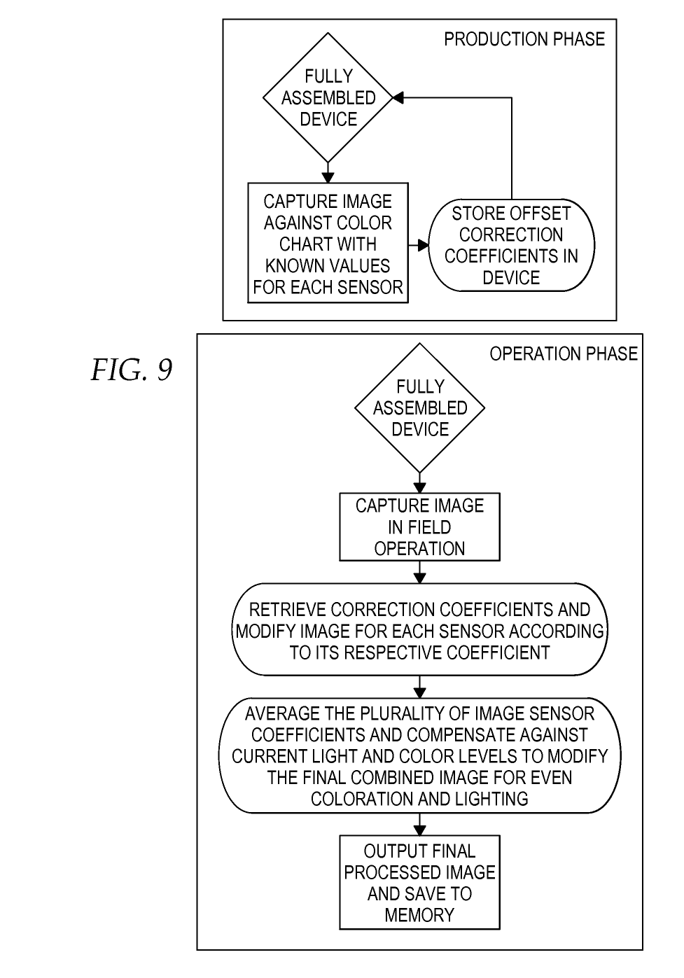

Each image sensor 16 manufactured has a specified tolerance that results in the sensor 16 having a variance in the red, green and blue color component of its output. In single image sensor 16 devices, this is not an issue as the microprocessor unit includes a digital signal processor (DSP) which compensates for this variance to produce a true corrected value in the output. In devices with multiple image sensors 16, without color compensation or presorting the devices during manufacturing, the resultant combined or panoramic image will have non-color-matched output on the final image as there is an inherent differential between the outputs from each device. This new device solves this problem with a specially designed algorithm and software which corrects for the deviation between each image sensor 16 to create a compensation coefficient for each sensor 16 such that the final combined image shows no or minimal noticeable deviation in color from each individual segment of the image. After final assembly of the camera unit 10, a test image is captured against a color chart with known values. The RGB color components of the resultant image are measured to generate a sensor characteristic coefficient including, but not limited to color offset and gain, black level, and white balance and overall response for each individual image capture sensor 16 within the plurality of such sensors. These characteristic values are then saved within the camera unit's internal memory. When in subsequent use, upon completion of capture and during the image post processing stage, the camera modifies each Red, Green and Blue color component for each pixel of each image capture sensor 16 against their respective sensor characteristics in tandem with compiled variables based on the combination of each color channel and each sensor 16 through a specific formula to create an ideal and level color image in the final output as shown in FIG. 9.

An additional advantage over existing products is that the device has the ability to initiate the capture sequence in whichever zone originally detects motion instead of having to utilize a dedicated starting location or reposition an aperture mechanically. This allows for quicker capture of the desired subject as soon as it is detected, preventing the potential for the subject to exit the field of view before sequencing reaches the subject's respective zone. In this embodiment, the first image captured will always be the zone in which movement is detected, allowing the remaining sequencing to be follow-up captures secondary to the primary function of capturing the activity of the subject which triggered the capture originally.

Alternatively, the system can record video in which the video capture can switch sensors reactively based on game movement, such that if the game were to move from the initial zone A to zone B, the motion detector sensor of zone B would trigger the microprocessor unit 18 to terminate capture in zone A and begin capture in zone B to follow the movement of the subject. In lieu of a single image sensor 16 that rotates to a desired position, the device utilizes multiple image sensors 16 in fixed positions to capture a wider field of view.

In another embodiment, the unit contains a single motion detection unit which serves to signal the microprocessor unit 18 to activate the image sensor 16s in sequence. In this embodiment, the sequence can be alternated such that the image sensor 16 in any zone may be selected to actuate first. This arrangement provides a useful and relatively inexpensive unit for use in locations where the prevailing winds blow across the field of view or in mountainous areas where game animals move against the rising and settling air during the cycle of a day. Thus, if the wind direction is from right to left across the field of view, the user would choose to activate the left image sensor 16 first since game animals would likely be moving into the wind.

While in the foregoing specification this invention has been described in relation to certain embodiments thereof, and many details have been put forth for the purpose of illustration, it will be apparent to those skilled in the art that the invention is susceptible to additional embodiments and that certain of the details described herein can be varied considerably without departing from the basic principles of the invention.

What we claim is:

1. A surveillance camera system having a plurality of camera apertures facing radially outward from a common center and on a common plane, each of said apertures having a field of view of from 40 to 75 degrees with said field of view of each of said plurality of camera apertures bounded by the field of view of each adjacent aperture, each aperture cooperatively positioned relative to an associated image capture sensor on which said field of view of the associated camera aperture is focused, a microprocessor unit receiving electronic image input from each of said associated image capture sensors and programmed to selectively combine each electronic image input to yield a panoramic image spanning the combined field of view of all of the plurality of camera apertures, and a plurality of motion detector sensors, each motion detector sensor associated with one of said plurality of camera apertures and having a field of view coextensive with said one of said plurality of camera apertures, each of said motion detector sensors operatively connected to said microprocessor unit to provide an input thereto indicative of a moving body in a field of view coextensive with an associated one of said plurality of camera apertures, wherein said microprocessor unit is programmed to activate the image capture sensor having the moving body within its focused field of view; and electronic memory connected to said microprocessor unit for storing data including said electronic image input and said panoramic image.

2. The camera system of claim 1 further comprising an LED array 30 for illuminating the field of view of each of said apertures.

3. The camera system of claim 2 wherein said LED array comprises a plurality of LED emitters positioned to illuminate the field of view associated with one of said camera apertures.

4. The camera system of claim 3 wherein the LED array comprises a second plurality of LED emitters positioned to illuminate the field of view associated with a second camera aperture adjacent said one of said camera apertures.

5. The camera system of claim 2 wherein said microprocessor unit is programmed to selectively activate a plurality of LEDs in said LED array positioned to illuminate the field of view of a camera aperture in which a moving body has been detected by one of said plurality of motion detector units and further comprising a light sensor detecting the ambient light and communication with said microprocessor unit such that said microprocessor unit selectively activates said plurality of LEDs in said LED array when said detected ambient light is below a predetermined threshold.

6. The camera system of claim 1 wherein each of said camera apertures in said plurality of camera apertures has a field of view of 60 degrees and said field of view does not substantially overlap with any field of view of any adjacent camera aperture.

7. The camera system of claim 6 wherein said plurality of camera apertures includes only 3 camera apertures.

8. The camera system of claim 7 wherein said microprocessor unit is programmed to correct for color deviation between each image sensor to create a compensation coefficient for each sensor such that the panoramic image shows no or minimal noticeable deviation in color from each individual segment of the image.

9. The camera system of 1 wherein said microprocessor unit is programmed to actuate at least one image capture sensor associated with a camera aperture adjacent a camera aperture whose associated image capture sensor has been actuated by the presence of a moving body.

10. The camera system of claim 1 wherein said microprocessor unit is programed to actuate each of the image capture sensors in a predetermined sequence depending on which image capture sensor is actuated first.

11. A method of capturing images of a panoramic scene having at least one moving body therein comprising:
a. Providing a plurality of camera apertures mounted in a single housing with each aperture having a field of view including a portion of said panoramic scene;
b. Providing an image capture sensor associated with each of said plurality of camera apertures;
c. Providing a microprocessor unit receiving input from said image capture sensors;
d. Providing a plurality of motion detector sensors with each motion detector sensor of said plurality of motion detector sensors associated with one of said plurality of camera apertures and having a field of view commensurate with the field of view of the associated camera aperture;
e. Detecting the presence of a moving body in any field of view of any of said motion detector sensors and initiating actuation of an associated image capture sensor;
f. Actuating of each of the image capture sensors in sequence subsequent to the detecting of said moving body;
g. Storing images from each of said image capture sensors in memory;
h. Selectively combining said images from each of said image capture sensors to create a panoramic image of said panoramic scene; and
i. Storing said panoramic image in memory.

12. The method of claim 11 in which each of said apertures are positioned at the same level relative to said panoramic scene.

13. The method of claim 11 further comprising correcting for color deviation between each image sensor to create a compensation coefficient for each sensor such that the panoramic image shows no or minimal noticeable deviation in color from each individual segment of the image.

14. The method of claim 13 wherein said selective combining step includes pattern matching of said images relative to each other image to be combined therewith.

15. The method of claim 11 further comprising actuating at least one image capture sensor associated with a camera aperture adjacent a camera aperture whose associated image capture sensor has been actuated by the presence of a moving body.

16. The method of claim 11 further comprising providing an LED array for illuminating the field of view of each of said apertures.

17. The method of claim 16 further comprising selectively activating a plurality of LEDs in said LED array positioned to illuminate the field of view of a camera aperture in which a moving body has been detected by one of said plurality of motion detector sensors and further comprising detecting the ambient light such that said microprocessor units electively activates said plurality of LEDs in said LED array when said detected ambient light is below a predetermined threshold.

18. The method of claim 11 wherein each of said camera apertures in said plurality of camera apertures has a field of view of 60 degrees and said field of view does not substantially overlap with any field of view of any adjacent camera aperture.

19. A surveillance camera system having a plurality of camera apertures facing radially outward from a common center and on a common plane, each of said camera apertures having a field of view of from 40 to 75 degrees with said field of view of each of said plurality of camera apertures bounded by the field of view of each adjacent camera aperture, each camera aperture cooperatively positioned relative to an associated image capture sensor on which said field of view of the associated aperture is focused, a microprocessor unit receiving electronic image input from each of said associated image capture sensors and programmed to selectively combine each electronic image input to yield a panoramic image spanning the combined field of view of all of the plurality of camera apertures and at least one motion detector sensor associated with said microprocessor unit to provide an input thereto indicative of a moving body in a field of view coextensive with one of said plurality of camera apertures, wherein said microprocessor unit is programmed to activate the image capture sensor having the moving body within its focused field of view; and thereafter activate the remaining image capture sensors, electronic memory connected to said microprocessor unit for storing data including said electronic image input from each image capture sensor and said panoramic image.

20. A surveillance camera system as in claim 19 further including a timer operably connected to said microprocessor unit to trigger a sequence of image captures after a predetermined passage of time.
